(19) United States
(12) Patent Application Publication
(10) Pub. No.: US 2015/0271561 A1
(43) Pub. Date: Sep. 24, 2015

(54) SYSTEM AND METHOD FOR CONTROLLING MULTI SOURCE AND MULTI DISPLAY

(71) Applicant: Hyundai Motor Company, Seoul (KR)

(72) Inventor: Un Kyu Park, Seoul (KR)

(21) Appl. No.: 14/482,366

(22) Filed: Sep. 10, 2014

(30) Foreign Application Priority Data
Mar. 21, 2014 (KR) 10-2014-0033537

(51) Int. Cl. H04N 21/485; H04N 21/214; H04N 21/41; G02B 27/01; H04N 21/414

(52) U.S. Cl. CPC H04N 21/485; G02B 27/0101; H04N 21/41422; H04N 21/4122; H04N 21/4126; H04N 21/214

(57) ABSTRACT

A system and method for controlling multi source and multi display are provided. The method includes visually displaying, by a controller, at least one source device disposed within a vehicle and supplying a video or sound through a graphical user interface (GUI) and selecting the source device for interworking with at least one display device within the vehicle of the at least one source device through the GUI. Contents are selected by the controller for sharing with the display device of a video or sound supplied by the selected source device through GUI and the at least one display device is visually displayed with a position within the vehicle through the GUI. The display device is selected for outputting the contents of the at least one display device through the GUI and the contents are transmitted by the controller to the selected display device through the GUI.

### CROSS-REFERENCE TO RELATED APPLICATION

This application is based on and claims priority from Korean Patent Application No. 10-2014-0033537, filed on Mar. 21, 2014 in the Korean Intellectual Property Office, the disclosure of which is incorporated herein in its entirety by reference.

### BACKGROUND

1. Field of the Invention

The present invention relates to a system and method for controlling multi source and multi display, and more particularly, to a system and method for controlling multi source and multi display sharing and setting a screen based on a position within a vehicle of a display device.

2. Description of the Prior Art

A display device is a device which processes a video signal provided from a source which supplies the video signal and displays the signal on a display. Recent vehicles are being developed with a plurality of display devices. For example, as well as a cluster and a head unit of a vehicle, a display device is disposed in a head up display (HUD) of a driver, a passenger seat, and a rear seat.

As such vehicle having multi display devices is increasing and a source device which is the supply source that provides a video signal is also diversified together with the development of the display technology. For example, the demand for watching a video more stably on a larger screen is increasing by sharing the outputs of the source devices such as smart phone, tablet personal computer (PC), notebook computer, etc., to the display device disposed within a vehicle, together with the development of wireless communication technology.

In general, however, in the connection process for sharing the source device which is within a vehicle and the desire to be connected with the display device of the vehicle and the screen of multi display device within the vehicle, is the connect is shared based on information for the name or identification (ID) specifying the devices of the source device and the display device in advance. When one source device is connected to one display device by a general wired scheme, a separate setting is not required, but when multiple source devices are connected to multiple display devices, it may be difficult to set the source devices and the display devices.

### SUMMARY

The object of the present invention is to provide a system and method for controlling multi source and multi display which connects multiple display devices within a vehicle with multiple source devices within the vehicle with intuitive interface. Another object of the present invention is to provide a system and method for controlling multi source and multi display to be connected to the display device which a passenger (e.g., not a driver), when the screen of the source device is connected to the display device disposed within the vehicle.

A method for controlling multi source and multi display according to an exemplary embodiment of the present invention may include: visually displaying at least one source device disposed within a vehicle and supplying a video or sound through graphical user interface (GUI); selecting the source device for interworking with at least one display device disposed within the vehicle of the at least one source device through the GUI; electing a contents for sharing with the display device of a video or sound supplied by the selected source device through the GUI; visually displaying the at least one display device with a position disposed within the vehicle through the GUI; selecting the display device for outputting the contents of the at least one display device through the GUI; and transmitting the contents to the selected display device through the GUI.

A method for controlling multi source and multi display according to another exemplary embodiment of the present invention may include: visually displaying at least one display device disposed within a vehicle with a position disposed within the vehicle through GUI; selecting the display device for interworking with at least one source device disposed within a vehicle and supplying a video or sound of the at least one display device through the GUI; visually displaying the at least source device through the GUI; selecting the source device for interworking with the selected display device of the at least one source device through the GUI; selecting a contents for sharing with the selected display device of a video or sound supplied by the selected source device through the GUI; and transmitting the contents to the selected display device through the GUI.

In an exemplary embodiment, the GUI may be configured to visually display the at least one source device, the at least one display device, the video or sound, and the position using an icon, and may be configured to receive an input signal of a user by a click or drag and drop method. In addition, when the transmission of the contents to the selected display device is not possible according to driving regulations of the vehicle and the position, the method may further include displaying a notice indicating that the transmission of the contents is not possible through the GUI. Further, the at least one source device may include at least one of a wireless terminal possessed by the passenger of the vehicle and a plurality of display devices equipped with a multimedia system disposed within the vehicle. The at least one display device may include at least one of a head unit display of the vehicle, a cluster display of the vehicle, a head-up display, a passenger seat display, a rear seat display, and a wireless terminal possessed by the passenger of the vehicle.

A system and method for controlling multi source and multi display according to the present invention may connect multiple display devices within a vehicle with multiple source devices disposed within the vehicle with intuitive interface. In addition, it may be possible that contents that may cause distraction to a driver may be connected to only the passenger display device \, when the screen of the source device is connected to the display device disposed within the vehicle. In other words, a driver may be prevented from being distracted by displaying contents on display screens that are not visible to a driver.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram showing a display device and a source device disposed within a vehicle to which a method for controlling multi source and multi display of the present invention is applied according to an exemplary embodiment of the present invention;

FIG. 2 is an exemplary diagram showing multi source devices in a method for controlling multi source and multi display according to an exemplary embodiment of the present invention;

FIG. 3 is an exemplary diagram showing the process of interworking the screen of the source device with any one of multi display devices in a method for controlling multi source and multi display according to an exemplary embodiment of the present invention;

FIG. 4 is an exemplary diagram showing multi display devices in a method for controlling multi source and multi display according to another exemplary embodiment of the present invention;

FIG. 5 is an exemplary diagram showing the process of interworking the screen of the source device with any one of multi display devices in a method for controlling multi source and multi display according to another exemplary embodiment of the present invention;

FIG. 6 is an exemplary flowchart showing a method for controlling multi source and multi display according to an exemplary embodiment of the present invention; and

FIG. 7 is an exemplary diagram showing a method for controlling multi source and multi display according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The advantage and features of the present invention and how to achieve it will be explained through exemplary embodiments described in detail with the accompanying drawings. However, the invention is not limited to exemplary embodiments described herein and may be embodied in other aspects. Only, the present exemplary embodiment is provided for explaining to those skilled in the art to which this invention pertains in detail to the extent that it is possible to easily embody the technical spirit of the present invention.

In the drawings, exemplary embodiments of the present invention are not limited to the shown specific aspects and are exaggerated in order to clarify. Although specific terms are used herein, it is only used for explaining the present invention, and it is not used for limiting the meaning or the scope of the present invention described in the claims. The expression “and/or” herein is used as the meaning including at least one of components listed before and after the expression. Also, the expression “connected/coupled” is used as the meaning including being directly connected with another component or indirectly connected through another component. A singular form herein also includes a plural form unless it is specially referred in a phrase. Also, the components, steps, operations and elements referred as “comprise” or “comprising” used herein mean the presence or addition of at least one of other components, steps, operations and elements.

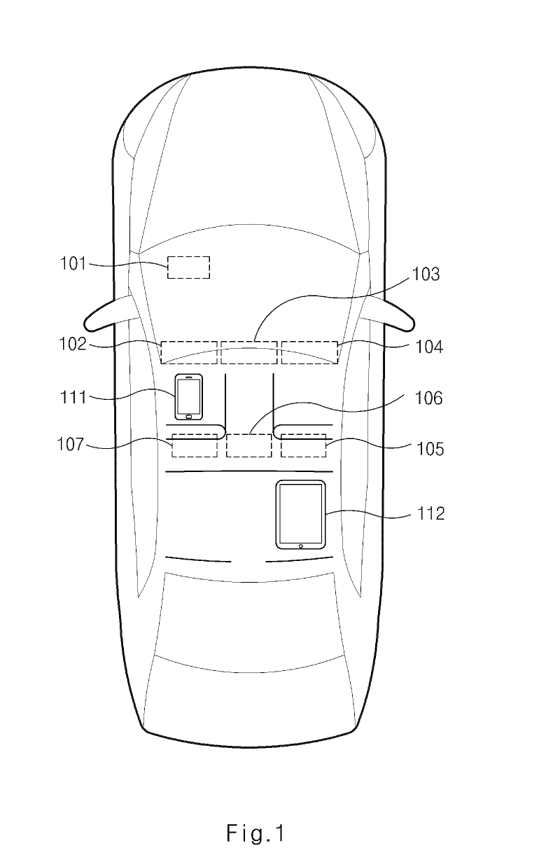

Hereinafter, with reference to the drawings an exemplary embodiment of the present invention will be described in detail. FIG. 1 is an exemplary diagram showing a display device and a source device disposed within a vehicle to which a method for controlling multi source and multi display of the present invention is applied. Referring to FIG. 1, the vehicle may include a plurality of display devices. Specifically, the vehicle may include a head-up display 101, a cluster display 102, a head unit display 103, a passenger seat display 104, and a rear seat display 105, 106, 107.

As each of the display device is a device for providing a video to the closest passenger of the vehicle, the head-up display 101 and the cluster display 102 may be configured to display information related to vehicle driving to the driver of the vehicle, the head unit display 103 may be configured to provide a video to the passenger in a front seat, the passenger seat display 104 may be configured to provide a video to the passenger in a passenger seat, and a rear seat display 105, 106, 107 may be configured to provide a video to the passengers in a rear seat. Additionally, the wireless terminal 111, 112 of vehicle passengers may be the display device within the vehicle.

In particular, the wireless terminal 111, 112 of the vehicle passengers may be a portable display device, and as a result, the portable display screen providing a video is generally smaller than other display devices 101 to 107 disposed within the vehicle. Additionally, since the wireless terminal 111, 112 is a portable device, the device may hold a greater variety of content than other display devices 101 to 107 disposed within the vehicle. A vehicle passenger may use the contents of the wireless terminal 111, 112 through the display device of the vehicle having a larger screen, and accordingly, the technology that interconnects other display devices 101 to 107 disposed within the vehicle and the passenger's wireless terminal 111, 112 and managing the connection is required.

Generally, the display devices 101 to 107 disposed within the vehicle and wireless terminal 111, 112 are connected through Bluetooth Pairing/Connection, Wi-Fi Connection, etc., and when connecting wireless communication, after recognizing the device to be connected through a unique ID of the devices in advance, interconnecting for the respective device may be attempted. In particular, when one source device is connected to one display device by interconnecting devices via a wired connection, a separate setting and recognition of a unique ID, etc. for the devices is not required. However, when multiple source devices and multiple display devices are interconnected, to connect the source device and the display device, as the above described, a unique ID for specifying each device is required, and as the number of the display device and source device increases, the interconnecting process may become complex for a user.

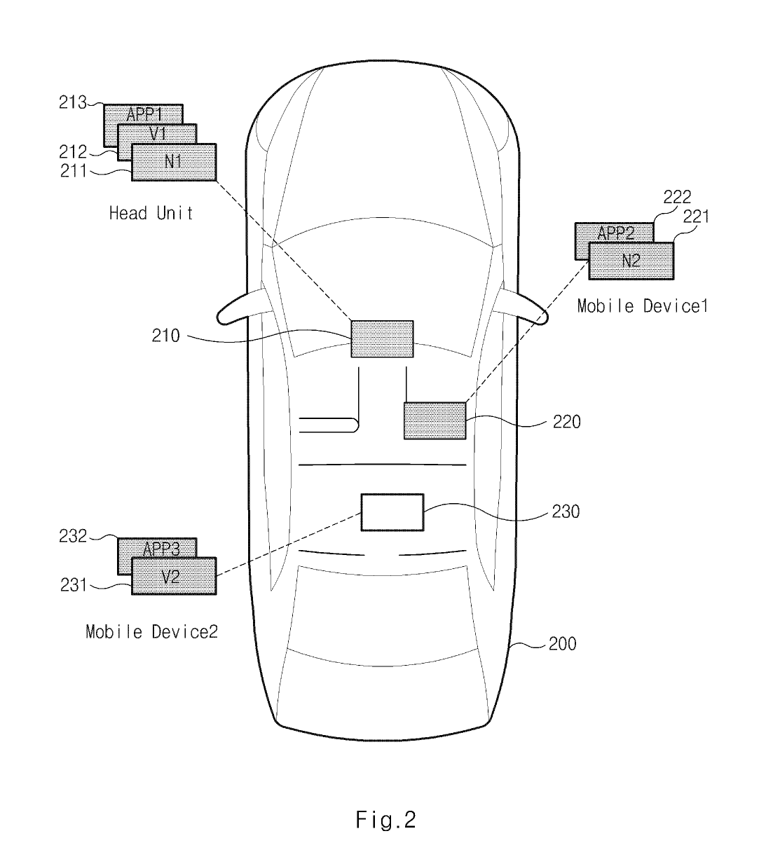

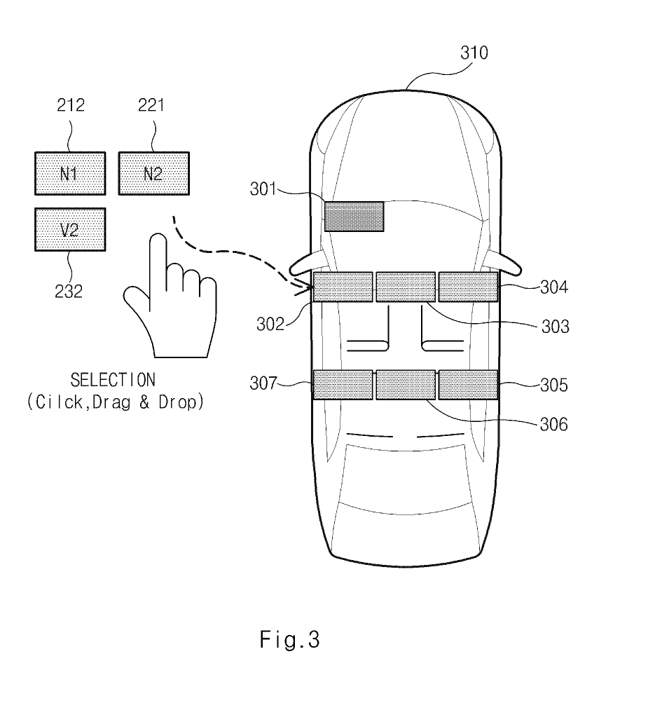

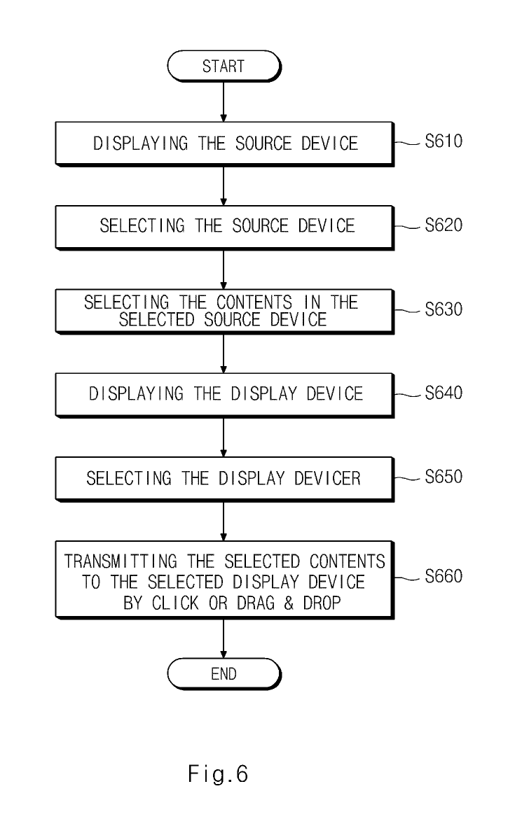

First, through FIG. 2, FIG. 3, and FIG. 6, a method for controlling multi source and multi display according to an exemplary embodiment of the present invention will be described. FIG. 2 is an exemplary diagram showing multi source devices in a method for controlling multi source and multi display according to an exemplary embodiment of the present invention. Referring to FIG. 2, three source devices 210, 220, 230 may be disposed within the vehicle 200. FIG. 3 is an exemplary diagram showing the process of interworking the screen of the source device with any one of multi display devices in a method for controlling multi source and multi display according to an exemplary embodiment of the present invention. Referring FIG. 3, the vehicle 310 may include a plurality of display device 301 to 307. FIG. 6 is an exemplary flowchart showing a method for controlling multi source and multi display according to an exemplary embodiment of the present invention.

First, at least one source device 210, 220, 230, disposed within the vehicle and is configured to output a video or sound, may be visually displayed through a graphical user interface (GUI) executed by a controller as shown in FIG. 2 (S610). The first source device 210 may be a head unit, and the second source device 220 may be a passenger wireless terminal at a passenger seat, the third source device 230 may be a passenger wireless terminal at a rear seat (e.g., a wireless terminal of a portable display device located at a rear seat). Each of these source devices 210, 220, 230 may be configured to execute a plurality of contents 211, 212, 213, 221, 222, 231, 232. Specifically, the first source device 210 may be configured to execute N1 (211), V1 (212), APP1 (213), the second source device 220 may be configured to execute N2 (221), APP2 (222), and the third source device 230 may be configured to execute V2 (231), APPS (232). Thereafter, the source device, configured to interwork with at least one display device 301 to 307 disposed within the vehicle, of at least one source device 210, 220, 230 may be selected through GUI (S620). In the case of FIG. 2 and FIG. 3, three source devices may be selected.

Thereafter, the contents for sharing with the display device of a video or sound supplied by the selected source device 210, 220, 230 may be selected through GUI (S630). Specifically, as shown in FIG. 2, the contents V1 (212), N2 (221), V2 (232), which the user of the vehicle desires to view through the display device 301 to 307 disposed within the vehicle, of a plurality of contents 211, 212, 213, 221, 222, 231, 232 which each of the source devices 210, 220, 230 existing in the vehicle is executing may be selected. At least one display device 301 to 307 may be visually displayed with the position provided in the vehicle 310 through GUI (S640). Specifically, the head-up display 301 may be displayed on the front windshield, the cluster display 302 may be displayed in the steering wheel of the driver seat, the head unit display 303 may be displayed between front seats, the passenger seat display 304 may be displayed in the passenger seat, the rear display 305, 306, 307 may be displayed in the position provided in the rear seat, respectively. Through such GUI, although the user may not recognize the unique ID or name of the display device, each of the display devices 301 to 307 may be intuitively identified.

Thereafter, the display device for outputting the contents selected in step S630 of at least one display device 301 to 307 may be selected through GUI (S650). Referring to FIG. 3, the cluster display 302 as a display device for outputting N2 (221) of the contents 212, 221, 232 was selected. The contents (N2; 221) may then be transmitted to the selected display device (e.g., cluster display; 302) through GUI (S660). In particular, the control signal input to the GUI may be a click or drag and drop method, the contents (N2; 221) may be transmitted to the display device (e.g., cluster display; 302) selected by click or drag & drop method input by the user.

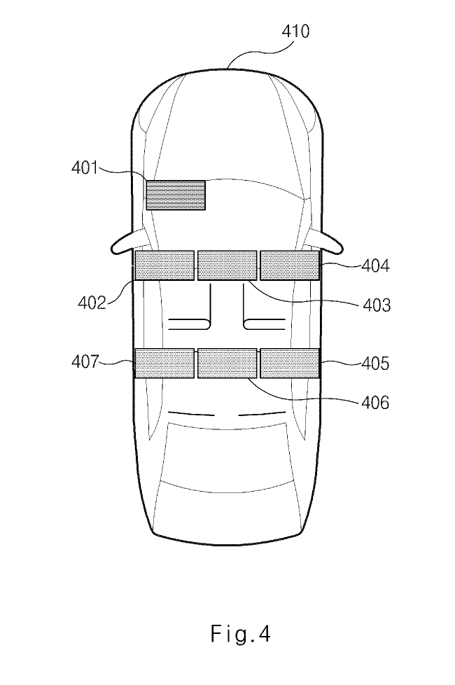

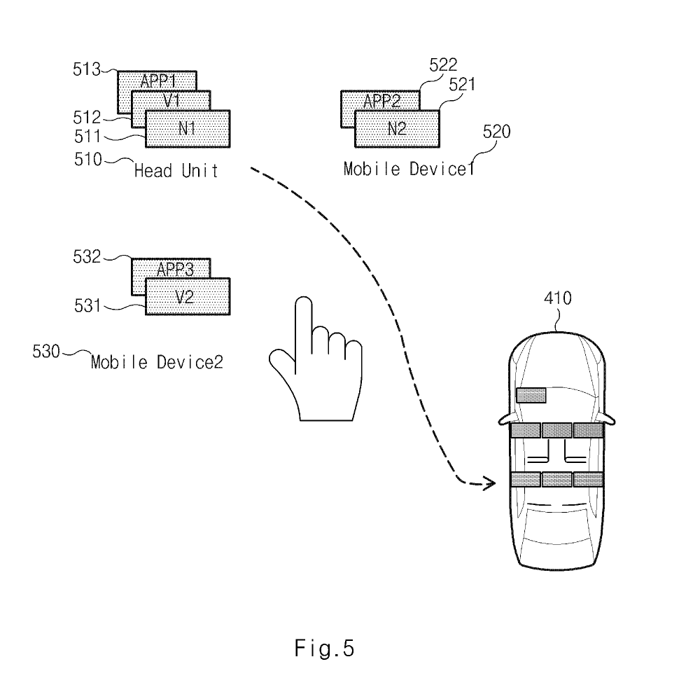

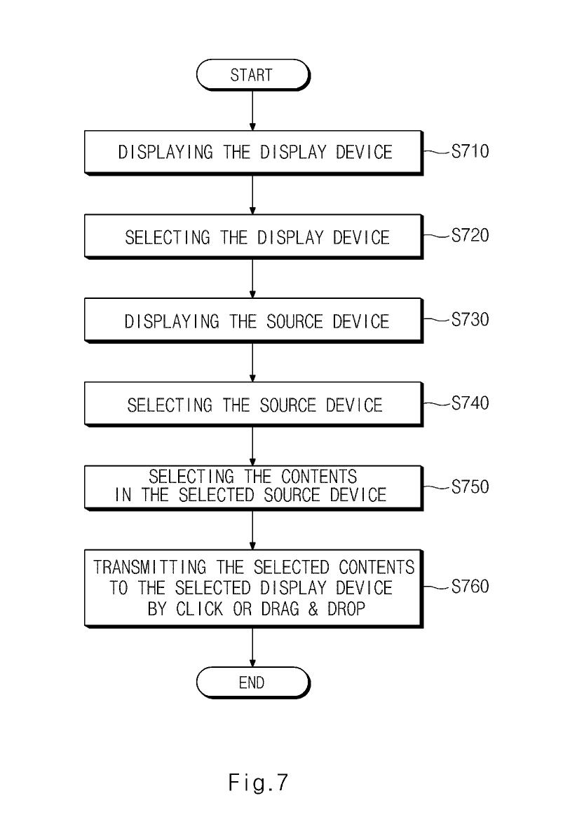

The method for controlling multi source and multi display described above through FIG. 2, FIG. 3, and FIG. 6 may be the method of selecting a source device. In addition, the manner of selecting a display device will be described through FIG. 4, FIG. 5, and FIG. 7 as below. FIG. 4 is an exemplary diagram showing multi display devices in a method for controlling multi source and multi display according to another exemplary embodiment of the present invention. Referring to FIG. 4, the vehicle 410 may include a plurality of display devices 401 to 407. FIG. 5 is an exemplary diagram showing the process of interworking the screen of the source device with any one of multi display devices in a method for controlling multi source and multi display according to another exemplary embodiment of the present invention. Referring to FIG. 5, three source devices 510, 520, 530 may be disposed within the vehicle 410. FIG. 7 is an exemplary diagram showing a method for controlling multi source and multi display according to another exemplary embodiment of the present invention.

First, at least one display device 401 to 407 may be visually displayed with a position disposed within the vehicle 410 through the GUI (S710). In other words, the display device 401 to 407 may be displayed at a particular location within the vehicle. Specifically, the head-up display 401 may be displayed on the front windshield, the cluster display 402 may be displayed in the steering wheel of the driver seat, the head unit display 403 may be displayed between front seats, the passenger seat display 404 may be displayed in the passenger seat, the rear display 405, 406, 407 may be displayed in the position provided in the rear seat, respectively. Through such a GUI, although the user may not recognize the unique ID or name of the display device, each of the display devices 401 to 407 may be intuitively identified.

Thereafter, the display device for sharing and outputting the contents, which the source device 510, 520, 530 executes, of at least one display device 401 to 407 may be selected through the GUI (S720). Referring to FIG. 4, the passenger seat display 404 and the rear seat display 405, 407 as a display device for sharing and outputting the contents which the source device 510, 520, 530 executes were selected. At least one source device 510, 520, 530, disposed within the vehicle and configured to output a video or sound, may be visually displayed through the GUI as shown in FIG. 5 (S730).

The first source device 510 may be a head unit, and the second source device 520 and the third source device 530 may be wireless terminals of the passengers (e.g., passenger portable display devices). Each of these source devices 510, 520, 530 may be configured to execute a plurality of contents 511, 512, 513, 521, 522, 531, 532. Specifically, the first source device 510 may be configured to execute N1 (511), V1 (512), APP1 (513), the second source device 520 may be configured to execute N2 (521), APP2 (522), and the third source device 530 may be configured to execute V2 (531), APPS (532). Thereafter, the source device, for interworking with at least one display device 401 to 407 disposed within the vehicle, of at least one source device 510, 520, 530 may be selected through the GUI (S740). In FIG. 4 and FIG. 5, the first source device 510, the head unit is selected.

Furthermore, the contents for sharing with the display device of a video or sound supplied by the selected source device 510 may be selected through GUI (S750). Specifically, as shown in FIG. 5, the contents N1 (511) desired to be displayed through the display device 401 to 407 disposed within the vehicle, of a plurality of contents 511, 512, 513, 521, 522, 531, 532 which each of the source devices 510, 520, 530 existing in the vehicle is executing may be selected. Thereafter, the contents (N1; 511) may be transmitted to the selected display device (e.g., rear seat display; 407) in step S720 through the GUI (S760). In particular, the control signal input to the GUI may be a click or drag and drop input method, the contents (N1; 511) may be transmitted to the display device (e.g., rear seat display; 407) selected by click or drag and drop method input by the user.

The method for controlling multi source and multi display described above through FIG. 4, FIG. 5, and FIG. 7 may be a method of selecting a display device. In the method for controlling multi source and multi display of FIG. 6 and FIG. 7, the GUI may be executed by a controller to visually display at least one source device, at least one display device, contents supplied by the source device and the position within the vehicle of the display device through an ICON, and may be configured to receive the input signal by the click or drag and drop input.

In addition, recently, while a multimedia system is disposed within a vehicle, regulations related to safety driving of a vehicle may be generated. For example, holding a telephone by hand while driving may distract a driver from operating the vehicle thus increasing the possibility of a vehicle collision. As a result, safety regulations have been implemented that require a driver to use a hands-free method of using a telephone. Another subject of such regulations include displaying and/or watching a video while driving. Accordingly, based on these regulations of safe driving, the method for controlling multi source and multi display may be configured to restrict the interworking of the display devices. In particular, the method may include interworking only the display device of a passenger when interworking the contents such a video, a game that may distract the driver from operating the vehicle when the passenger connects the wireless terminal to the display device within the vehicle and shares the contents. Specifically, when a specific content is prevented from being transmitted to the display device selected in step S650 and step S720 according to the driving restriction for safe driving, a notice may be displayed through the GUI indicating that the contents may not be transmitted to the selected display device.

In the method for controlling multi source and multi display, for convenience of description, the passenger wireless terminal is described as a source device and display disposed within the vehicle is described as a display device, but the present invention is not limited thereto. For example, to output the video provided to the head unit of the vehicle to the passenger wireless terminal in the rear seat possesses, the wireless terminal may be display device. In particular, the display device equipped with the multimedia system within the vehicle may be the source device, and the passenger wireless terminal may be the display device. In other words, each of all devices disposed within the vehicle may operate as a source device and a display device.

Accordingly, the method for controlling multi source and multi display visually provides a plurality of source devices and a plurality of display devices with the position within the vehicle of the devices through a GUI to allow the device to be intuitively recognized, and thus, provides intuitive and convenient usage environments since the transmission of the contents and selection of the device may be possible by a click or drag and drop input. Further, the contents interfering with safe driving may not be provided to the driver according to the position within the vehicle and driving regulations. That is, the present invention is capable of preventing particular display devices from displaying video content or the like when a driver may be considered to be distracted by such content

In the above description, the present invention has been described through specific examples, but it may be well understood that various modifications may be made without departing from the scope of the present invention. Therefore, the scope of the present invention is not limited to the above described exemplary embodiments, and it should be defined by the appended claims and their equivalents. When taking the foregoing description into account, if the modifications and variations of the present invention fall within the following claims and their equivalents, then it is construed that the present invention includes these modifications and variations.

What is claimed is:

1. A method for controlling multi source and multi display, comprising:
visually displaying, by a controller, at least one source device disposed within a vehicle and supplying a video or a sound through a graphical user interface (GUI);
selecting, by the controller, a particular source device for interworking with at least one display device disposed within the vehicle of the at least one source device through the GUI;
selecting, by the controller, contents for sharing with the display device of a video or a sound supplied by the selected source device through the GUI;
visually displaying, by the controller, the at least one display device with a position within the vehicle through the GUI;
selecting, by the controller, the display device for outputting the contents of the at least one display device through the GUI; and
transmitting, by the controller, the contents to the selected display device through the GUI.

2. The method of claim 1, wherein the GUI is executed by the controller to visually display the at least one source device, the at least one display device, the video or sound, and the position using an icon, and receive an input signal via a click or drag and drop user input

3. The method of claim 1, further comprising:
outputting, by the controller, through the GUI a notification indicating that the contents are not transmitted to the selected display device based on driving regulations of the vehicle.

4. The method of claim 1, wherein the at least one source device includes at least one of a passenger wireless terminal and a plurality of display devices equipped with a multimedia system disposed within the vehicle.

5. The method of claim 1, wherein the at least one display device includes at least one of a group consisting of: a head unit display of the vehicle, a cluster display of the vehicle, a head-up display, a passenger seat display, a rear seat display, and a passenger wireless terminal

6. A method for controlling multi source and multi display, comprising:
visually displaying, by a controller, at least one display device disposed within a vehicle with a position within the vehicle through a graphical user interface (GUI);
selecting, by the controller, the display device for interworking with at least one source device disposed within a vehicle and supplying a video or a sound of the at least one display device through the GUI;
visually displaying, by the controller, the at least source device through the GUI;
selecting, by the controller, the source device for interworking with the selected display device of the at least one source device through the GUI;
selecting, by the controller, contents for sharing with the selected display device of the video or sound supplied by the selected source device through the GUI; and
transmitting, by the controller, the contents to the selected display device through the GUI.

7. A method for controlling multi source and multi display according to claim 2, wherein the GUI is executed by the controller to visually display the at least one source device, the at least one display device, the video or sound, and the position using an icon, and receive an input signal via a click or drag and drop user input

8. A method for controlling multi source and multi display according to claim 2, further comprising:
outputting, by the controller, through the GUI a notification indicating that the contents are not transmitted to the selected display device based on driving regulations of the vehicle.

9. A method for controlling multi source and multi display according to claim 2, wherein the at least one source device includes at least one of a passenger wireless terminal and a plurality of display devices equipped with a multimedia system disposed within the vehicle.

10. A method for controlling multi source and multi display according to claim 2, wherein the at least one display device includes at least one of a group consisting of: a head unit display of the vehicle, a cluster display of the vehicle, a head-up display, a passenger seat display, a rear seat display, and a passenger wireless terminal.

11. A system for controlling multi source and multi display, comprising:
a memory configured to store program instructions; and
a processor configured to execute the program instructions, the program instructions when executed configured to:
visually display at least one source device disposed within a vehicle and supplying a video or a sound through a graphical user interface (GUI);
select a particular source device for interworking with at least one display device disposed within the vehicle of the at least one source device through the GUI;
select contents for sharing with the display device of a video or a sound supplied by the selected source device through the GUI;
visually display the at least one display device with a position within the vehicle through the GUI;
select the display device for outputting the contents of the at least one display device through the GUI; and
transmit the contents to the selected display device through the GUI.

12. The system of claim 11, wherein the program instructions when executed are further configured to visually display the at least one source device, the at least one display device, the video or sound, and the position using an icon, and receive an input signal via a click or drag and drop user input

13. The system of claim 11, wherein the program instructions when executed are further configured to output through the GUI a notification indicating that the contents are not transmitted to the selected display device based on driving regulations of the vehicle.

14. The system of claim 11, wherein the at least one source device includes at least one of a passenger wireless terminal and a plurality of display devices equipped with a multimedia system disposed within the vehicle.

15. The system of claim 11, wherein the at least one display device includes at least one of a group consisting of: a head unit display of the vehicle, a cluster display of the vehicle, a head-up display, a passenger seat display, a rear seat display, and a passenger wireless terminal

16. A non-transitory computer readable medium containing program instructions executed by a controller, the computer readable medium comprising:
program instructions that visually display at least one source device disposed within a vehicle and supplying a video or a sound through a graphical user interface (GUI);
program instructions that select a particular source device for interworking with at least one display device disposed within the vehicle of the at least one source device through the GUI;
program instructions that select contents for sharing with the display device of a video or a sound supplied by the selected source device through the GUI;
program instructions that visually display the at least one display device with a position within the vehicle through the GUI;
program instructions that select the display device for outputting the contents of the at least one display device through the GUI; and
program instructions that transmit the contents to the selected display device through the GUI.

17. The non-transitory computer readable medium of claim 16, further comprising program instructions that visually display the at least one source device, the at least one display device, the video or sound, and the position using an icon, and receive an input signal via a click or drag and drop user input

18. The non-transitory computer readable medium of claim 16, wherein the at least one source device includes at least one of a passenger wireless terminal and a plurality of display devices equipped with a multimedia system disposed within the vehicle.

19. The non-transitory computer readable medium of claim 16, wherein the at least one display device includes at least one of a group consisting of: a head unit display of the vehicle, a cluster display of the vehicle, a head-up display, a passenger seat display, a rear seat display, and a passenger wireless terminal.
